(19) United States
(12) Patent Application Publication
(10) Pub. No.: US 2024/0227176 A1
(43) Pub. Date: Jul. 11, 2024

(54) ROBOT SYSTEM, CONTROL DEVICE, AND CONTROL METHOD

(71) Applicant: SONY GROUP CORPORATION, TOKYO (JP)

(72) Inventors: KEN KOBAYASHI, TOKYO (JP); YOSHIAKI SAKAKURA, TOKYO (JP); KEI TSUKAMOTO, TOKYO (JP); TETSURO GOTO, TOKYO (JP); MANAMI MIYAWAKI, TOKYO (JP); HAYATO HASEGAWA, TOKYO (JP)

(21) Appl. No.: 18/556,215

(22) PCT Filed: Mar. 15, 2022
(86) PCT No.: PCT/JP2022/011669

§ 371 Date: Oct. 19, 2023

(30) Foreign Application Priority Data
May 11, 2021 (JP) 2021-080168

(51) Int. Cl. B25J 9/16; B25J 13/08; G01L 1/14; G01L 5/00

(52) U.S. Cl. CPC B25J 9/1612; B25J 9/1633; B25J 13/085; G01L 1/142; G01L 5/009

(57) ABSTRACT

To perform control for stably gripping a workpiece. Provided is a robot system including: a robot; and a control device that controls a robot, the robot including an actuator unit and an end effector provided at a distal end of the actuator unit, the end effector including a three-axis sensor configured to be capable of detecting a gripping force of the end effector and a shear force acting on a gripping surface of the end effector, and the control device controlling the gripping force of the end effector on the basis of a friction coefficient prescribed in advance and the shear force detected by the three-axis sensor.

### TECHNICAL FIELD

The present disclosure relates to a robot system, a control device, and a control method.

### BACKGROUND ART

In recent years, industrial robots have been used in production lines of various industrial products. As the industrial robot, one including an end effector (robot hand) at a distal end of a robot arm has been widely known. As the end effector, end effectors having various configurations according to work contents are proposed (see, for example, Patent Documents 1 and 2).

### CITATION LIST

### Patent Document

Patent Document 1: Japanese Patent Application Laid-Open No. 2006-297542
Patent Document 2: Japanese Patent Application Laid-Open No. 2008-55540

### SUMMARY OF THE INVENTION

### Problems to be Solved by the Invention

In such a field, it is desired that a target object (hereinafter, appropriately referred to as a workpiece) to be gripped by the end effector can be stably gripped.

The present disclosure aims to provide a robot system capable of stably gripping a workpiece, a control device, and a control method.

### Solutions to Problems

In order to solve the above problem, a first disclosure relates to a robot system including:

a robot; and

a control device that controls a robot, in which

the robot includes an actuator unit and an end effector provided at a distal end of the actuator unit,

the end effector includes a three-axis sensor configured to be capable of detecting a gripping force of the end effector and a shear force acting on a gripping surface of the end effector, and

the control device controls the gripping force of the end effector on the basis of a friction coefficient prescribed in advance and the shear force detected by the three-axis sensor.

A second disclosure relates to a control device including

a control unit that controls an end effector on the basis of a detection result of a three-axis sensor, in which

the three-axis sensor is configured to be capable of detecting a gripping force of the end effector and a shear force acting on a gripping surface of the end effector, and

the control unit controls the gripping force of the end effector on the basis of a friction coefficient prescribed in advance and the shear force detected by the three-axis sensor.

A third disclosure relates to a control method including:

detecting, by a three-axis sensor, a shear force acting on a gripping surface of an end effector; and

controlling a gripping force of the end effector on the basis of a friction coefficient prescribed in advance and the shear force detected by the three-axis sensor.

### BRIEF DESCRIPTION OF DRAWINGS

FIG. 1 is a schematic diagram illustrating an example of a configuration of a robot system according to an embodiment of the present disclosure.

FIG. 2 is a block diagram illustrating an example of the configuration of the robot system according to the embodiment of the present disclosure.

FIG. 3 is a schematic view illustrating an example of a configuration of a robot hand.

FIG. 4 is a cross-sectional view illustrating an example of a configuration of a force sensor.

FIG. 5 is a plan view illustrating an example of a configuration of a detection layer.

FIG. 6 is a cross-sectional view illustrating an example of the configuration of the detection layer.

FIG. 7 is a plan view illustrating an example of a configuration of a sensing unit.

FIG. 8 is a plan view illustrating an example of an arrangement of a plurality of routing wirings.

FIG. 9 is a cross-sectional view for describing an example of an operation of the force sensor at the time of pressure detection.

FIG. 10 is a cross-sectional view for describing an example of an operation of the force sensor at the time of shear force detection.

FIG. 11 is a graph illustrating examples of output signal distributions of a first detection layer and a second detection layer in a state where only a pressure acts on the force sensor.

FIG. 12 is a graph illustrating examples of output signal distributions of the first detection layer and the second detection layer in a state where a shear force acts on the force sensor.

FIGS. 13A to 13F are views illustrating operation examples performed by the robot hand in the embodiment.

FIG. 14 is a view illustrating examples of the shear force and a gripping force.

FIG. 15 is a graph illustrating a relationship between the shear force, the gripping force, and a preset friction coefficient.

FIG. 16 is a flowchart illustrating a flow of an operation performed by the robot hand according to the embodiment.

FIG. 17 is a flowchart illustrating a flow of control performed when the robot hand lifts a workpiece in the embodiment.

FIG. 18 is a flowchart illustrating a flow of control performed when the robot hand moves the workpiece in the embodiment.

FIG. 19 is a flowchart illustrating a flow of control performed when the robot hand releases the workpiece in the embodiment.

FIGS. 20A to 20C are views referred to when an operation of re-holding the workpiece in the embodiment is described.

FIG. 21 is a graph illustrating transitions of the shear force and the gripping force when the workpiece is re-held.

FIG. 22 is a flowchart illustrating a flow of control performed when the robot hand re-holds the workpiece in the embodiment.

FIGS. 23A to 23C are views illustrating changes in a state when the robot hand re-holds an end portion of the workpiece in the embodiment.

FIG. 24 is a graph illustrating transitions of the shear force and the gripping force when the robot hand re-holds the end portion of the workpiece in the embodiment.

FIGS. 25A to 25C are views illustrating changes in a state when the robot hand re-holds a workpiece larger than finger portions of the robot hand in the embodiment.

### MODE FOR CARRYING OUT THE INVENTION

An embodiment of the present disclosure will be described in the following order with reference to the drawings. Note that the same or corresponding portions will be denoted by the same reference signs in all the drawings of the following embodiment.

### Embodiment

### MODIFIED EXAMPLES

### Embodiment

### [Configuration of Robot System]

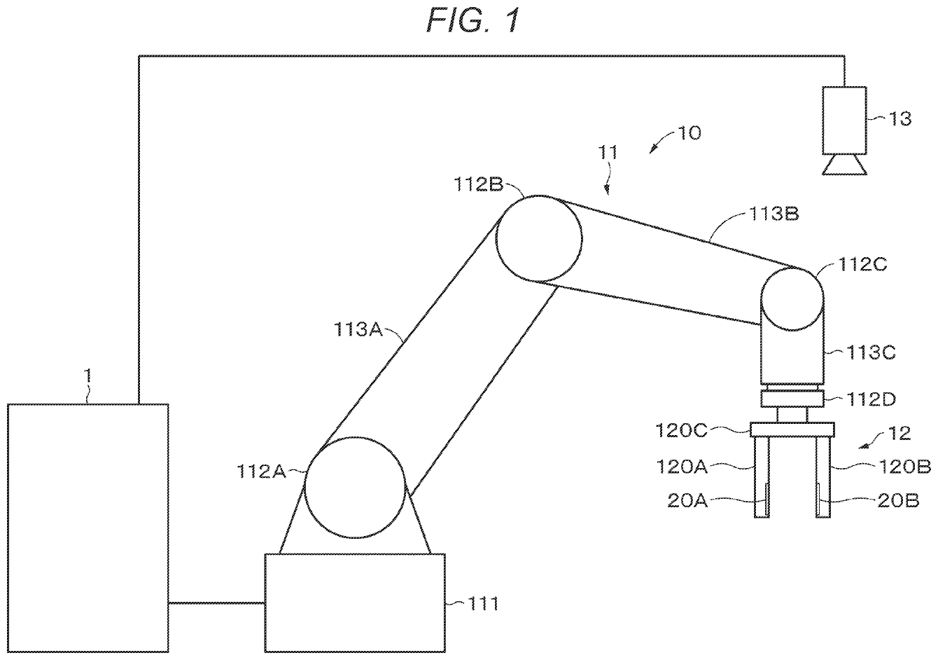

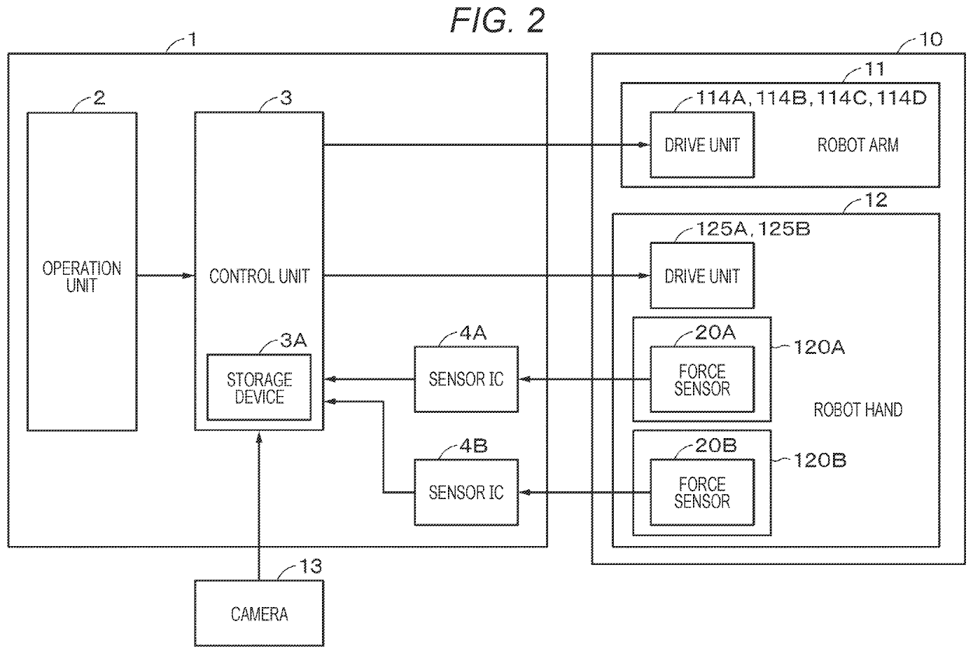

FIG. 1 is a schematic diagram illustrating an example of a configuration of a robot system according to an embodiment of the present disclosure. FIG. 2 is a block diagram illustrating an example of the configuration of the robot system according to the embodiment of the present disclosure. The robot system includes a robot control device 1, an articulated robot 10, and a camera 13. The articulated robot 10 is an industrial robot, and may be used for work such as assembly work, fitting work, conveyance work, palletizing work, and unpacking work. Specific examples of the assembly work include assembly work of a vehicle (for example, an automobile) or assembly work of an electronic device, gripping and/or assembling of a screw or a lens, taking stock of products such as PET bottles in a store, and the like, but are not limited to these types of work.

### (Articulated Robot)

The articulated robot 10 is a vertical articulated robot, and includes a robot arm 11 and a robot hand 12.

### (Robot Arm)

The robot arm 11 is an example of an actuator unit, and is configured to be capable of moving a position of an end effector in a three-dimensional space. The robot arm 11 includes a base portion 111, joint portions 112A, 112B, 112C, and 112D, and links 113A, 113B, and 113C. The base portion 111 supports the entire robot arm 11. The joint portions 112A, 112B, and 112C are configured to be capable of moving the robot arm 11 up and down and left and right and rotating the robot arm 11. The joint portion 112D is configured to be capable of rotating the robot hand 12.

The joint portions 112A, 112B, 112C, and 112D include drive units 114A, 114B, 114C, and 114D, respectively. As the drive units 114A, 114B, 114C, and 114D, for example, an electromagnetically driven actuator, a hydraulically driven actuator, a pneumatically driven actuator, and the like are used. The joint portion 112A connects the base portion 111 and the link 113A. The joint portion 112B connects the link 113A and the link 113B. The joint portion 112C connects the link 113B and the link 113C. The joint portion 112D connects the link 113C and the robot hand 12.

### (Robot Hand)

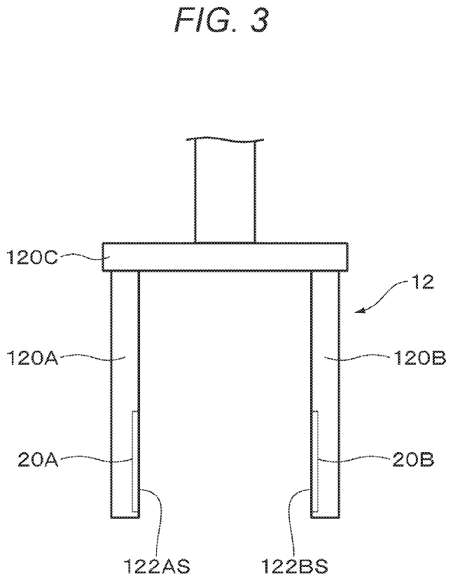

FIG. 3 is a schematic view illustrating an example of a configuration of the robot hand 12. The robot hand 12 is configured to be capable of gripping a workpiece. The robot hand 12 is provided at a distal end of the robot arm 11. The robot hand 12 is an example of the end effector. The robot hand 12 includes a proximal portion 120C, a plurality of finger portions 120A and 120B, and drive units 125A and 125B corresponding to the finger portions. Here, an example in which the robot hand 12 includes two finger portions 120A and 120B is described, but the number of finger portions is not limited thereto, and may be one or three or more. The robot hand 12 may be used to grip a plurality of types of workpieces, or may be used to grip one type of workpiece.

The proximal portion 120C is connected to the joint portion 112D. The proximal portion 120C may form a palm portion. The finger portion 120A and the finger portion 120B are connected to the proximal portion 120C. The finger portion 120A and the finger portion 120B are configured to be capable of gripping a workpiece. The finger portion 120A has a contact region 122AS that comes into contact with the workpiece at the time of prescribed work. The finger portion 120B has a contact region 122BS that comes into contact with the workpiece at the time of prescribed work. For example, the contact regions 122AS and 122BS are gripping surfaces that come into contact with the workpiece when the workpiece is gripped by the finger portions 120A and 120B. The drive unit 125A is configured to drive the finger portion 120A. The drive unit 125B is configured to drive the finger portion 120B.

The finger portion 120A includes a force sensor 20A. The force sensor 20A is provided in the contact region 122AS, for example. The finger portion 120B includes a force sensor 20B. The force sensor 20B is provided in the contact region 122BS, for example. The force sensors 20A and 20B correspond to examples of a three-axis sensor capable of detecting forces in three-axis directions. Note that each of the finger portions 120A and 120B has a linear shape in the present embodiment, but may be foldable with a joint portion as the center.

The force sensor 20A is configured to be capable of detecting a pressure distribution, a gripping force, and a shear force in the contact region 122AS. More specifically, the force sensor 20A detects the pressure distribution, the gripping force, and the shear force applied to the contact region 122AS on the basis of control of a sensor IC 4A, and outputs a detection result to the sensor IC 4A. The force sensor 20B is configured to be capable of detecting a pressure distribution, a gripping force, and a shear force in the contact region 122BS. More specifically, the force sensor 20B detects the pressure distribution, the gripping force, and the shear force applied to the contact region 122BS on the basis of control of a sensor IC 4B, and outputs a detection result to the sensor IC 4B.

The force sensor 20A is provided on a substrate such as a flexible substrate. The flexible substrate may be one of constituent components of the force sensor 20A. In the force sensor 20B, a flexible substrate provided on a substrate such as a flexible substrate may be one of constituent components of the force sensor 20B.

### (Robot Control Device)

The robot control device 1 is configured to control the articulated robot 10. The robot control device 1 includes an operation unit 2, a control unit 3, and the sensor ICs 4A and 4B.

### (Operation Unit)

The operation unit 2 is configured to operate the articulated robot 10. The operation unit 2 includes a monitor, a button, a touch panel, and the like to operate the articulated robot 10.

### (Control Device)

The control unit 3 controls the drive units 114A, 114B, 114C, and 114D and the drive units 125A and 125B according to the operation of the operation unit 2 performed by a worker, and causes the articulated robot 10 to perform prescribed work. The control unit 3 receives the pressure distributions, the gripping forces, and the shear forces in the contact regions 122AS and 122BS from the sensor ICs 4A and 4B, and controls the articulated robot 10 on the basis of the pressure distributions, the gripping forces, and the shear forces.

The control unit 3 includes a storage device 3A. The storage device 3A stores, for example, a prescribed friction coefficient and control information for causing the articulated robot 10 to perform predetermined work. The prescribed friction coefficient will be described later. The control information is information such as positions, angles, and movements of the joint portions 112A, 112B, 112C, and 112D and the robot hand 12. The control unit 3 controls the articulated robot 10 on the basis of these pieces of information such as the positions, angles, and movements, and causes the articulated robot 10 to perform the predetermined work. The storage device 3A may further store information regarding dimensions of a workpiece.

As described later, the force sensors 20A and 20B include a plurality of detection units, and signal values corresponding to the detection units are output to the sensor ICs 4A and 4B. An output value of each of the detection units is a dimensionless value (for example, 0 to 4095). The sensor ICs 4A and 4B may directly add the output values of all the detection units, calculate the sum of the output values, and output the sum to the control unit 3, and the control unit 3 may compare the sum of the output values with a threshold. Alternatively, the sensor ICs 4A and 4B may calibrate (calibrate) the output values of the respective detection units in advance, convert the output values into pressure values (kPa), and output the pressure values to the control unit, and the control unit 3 may compare the maximum output value (maximum pressure) among the output values of the detection units with a threshold. The latter example will be described in the present embodiment.

The control unit 3 detects a position of the workpiece on the basis of an image (image obtained by capturing the workpiece) received from the camera 13, and controls the articulated robot 10 on the basis of a detection result. Furthermore, the control unit 3 controls the gripping force of the robot hand 12 on the basis of the friction coefficient prescribed in advance and the shear forces detected by the force sensors 20A and 20B.

### (Sensor IC)

The sensors IC4A and IC4B are examples of a sensor control unit that controls the force sensors 20A and 20B. The sensor IC 4A controls the force sensor 20A to detect the pressure distribution, the gripping force, and the shear force in the contact region 122AS, and outputs a detection result to the control unit 3. The sensor IC 4B controls the force sensor 20B to detect the pressure distribution, the gripping force, and the shear force in the contact region 122BS, and outputs a detection result to the control unit 3. The sensor ICs 4A and 4B calibrate the output values of the force sensors 20A and 20B, respectively, at a prescribed timing such as before the start of work. Therefore, the sensor ICs 4A and 4B can detect accurate pressure distributions, gripping forces, and shear forces. Although an example in which the sensor ICs 4A and 4B are provided in the robot control device 1 is described in the present embodiment, the sensor ICs 4A and 4B may be provided on the flexible substrates included in the force sensors 20A and 20B, respectively.

### (Camera)

The camera 13 captures an image of a workpiece and outputs the captured image to the control unit 3. The camera 13 may be provided on the robot hand 12 or may be provided at a place, other than the robot hand 12, where the image of the workpiece can be captured.

### [Configuration of Force Sensor]

A configuration of the force sensor 20A will be described hereinafter since the force sensor 20B has a configuration similar to that of the force sensor 20A.

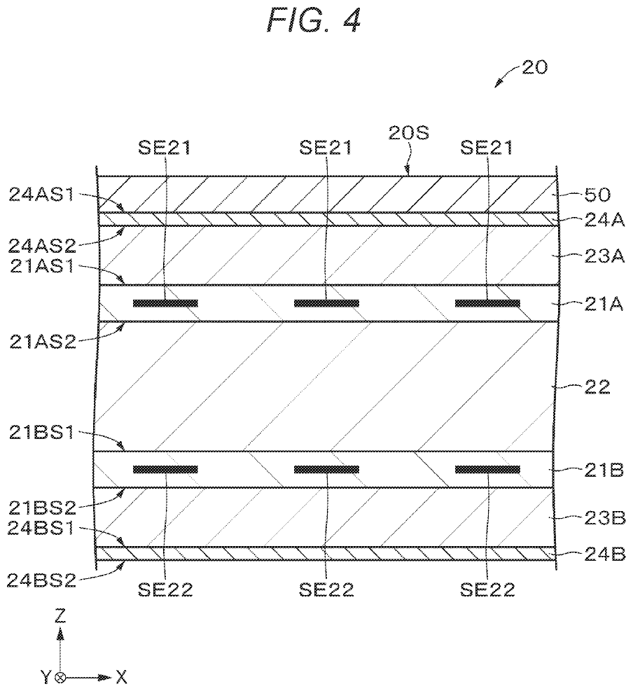

FIG. 4 is a cross-sectional view illustrating an example of the configuration of the force sensor 20A. The force sensor 20A is a capacitive sensor capable of detecting a three-axis force distribution, and detects a pressure acting on a surface of the force sensor 20A, in other words, the contact region 122AS which is the gripping surface of the robot hand 12, and a shear force in an in-plane direction of the force sensor 20A. The force sensor 20A has a film shape. Note that the film is defined to include a sheet in the present disclosure. The force sensor 20A has the film shape, and thus, can be applied not only to a flat surface but also to a curved surface. In the present specification, axes orthogonal to each other in the plane of the surface of the force sensor 20A in a flat state are referred to as an X axis and a Y axis, respectively, and an axis perpendicular to the surface of the force sensor 20A in the flat state is referred to as a Z axis.

The force sensor 20A includes a detection layer (first detection layer) 21A, a detection layer (second detection layer) 21B, a separation layer 22, a deformable layer (first deformable layer) 23A, a deformable layer (second deformable layer) 23B, a conductive layer (first conductive layer) 24A, and a conductive layer (second conductive layer) 24B. An adhesive layer (not illustrated) is provided between the respective layers of the force sensor 20A, whereby the respective layers are bonded to each other. However, the adhesive layer is not necessarily provided in a case where at least one of two adjacent layers has adhesiveness. Out of both surfaces of the force sensor 20A, a first surface on the conductive layer 24A side is a sensing surface 20S that detects the pressure and shear force, and a second surface on the opposite side of the sensing surface 20S is a back surface bonded to the contact region 122AS of the finger portion 120A. The detection layers 21A and 21B are connected to the sensor IC 4A via a wiring. An exterior member 50 such as an exterior film is provided on the conductive layer 24A. The exterior member 50 preferably includes a member whose surface is less slippery, for example, at least one material selected from the group consisting of rubber, gel, foam, and the like.

The detection layer 21A has a first surface 21AS1 and a second surface 21AS2 on the opposite side of the first surface 21AS1. The detection layer 21B has a first surface 21BS1 opposing the first surface 21AS1 and a second surface 21BS2 on the opposite side of the first surface 21BS1. The detection layer 21A and the detection layer 21B are arranged in parallel. The separation layer 22 is provided between the detection layer 21A and the detection layer 21B. The conductive layer 24A is provided to oppose the first surface 21AS1 of the detection layer 21A. The conductive layer 24A is arranged in parallel with the detection layer 21A. The conductive layer 24B is provided to oppose the second surface 21BS2 of the detection layer 21B. The conductive layer 24B is arranged in parallel with the detection layer 21B. The deformable layer 23A is provided between the detection layer 21A and the conductive layer 24A. The deformable layer 23B is provided between the detection layer 21B and the conductive layer 24B.

### (Detection Layer)

The detection layer 21A and the detection layer 21B are detection layers of a capacitance type, more specifically, a mutual capacitance type. The detection layer 21A has flexibility. The detection layer 21A is bent toward the detection layer 21B when a pressure acts on the sensing surface 20S. The detection layer 21A includes a plurality of sensing units (first sensing units) SE21. The sensing units SE21 detect the pressure acting on the sensing surface 20S and outputs a detection result to the sensor IC 4A. Specifically, the sensing units SE21 detect a capacitance corresponding to a distance between the sensing unit SE21 and the conductive layer 24A, and outputs a detection result to the sensor IC 4A.

The detection layer 21B has flexibility. The detection layer 21B is bent toward the conductive layer 24B when a pressure acts on the sensing surface 20S. The detection layer 21B includes a plurality of sensing units (second sensing units) SE22. The sensing units SE22 detect the pressure acting on the sensing surface 20S and outputs a detection result to the sensor IC 4A. Specifically, the sensing units SE22 detect a capacitance corresponding to a distance between the sensing unit SE22 and the conductive layer 24B, and outputs a detection result to the sensor IC 4A.

An arrangement pitch P1 of the plurality of sensing units SE21 included in the detection layer 21A is the same as an arrangement pitch P2 of the plurality of sensing units SE22 included in the detection layer 21B. The sensing unit SE22 is provided at a position opposing the sensing unit SE21 in an initial state where no shear force is applied. That is, the sensing unit SE22 and the sensing unit SE22 overlap in a thickness direction of the force sensor 20A in the initial state where no shear force is applied. However, it is also possible to adopt a configuration in which the sensing unit SE22 is not provided at the position opposing the sensing unit SE21 in the initial state where no shear force is applied.

Since the detection layer 21B has a configuration similar to that of the detection layer 21A, only the configuration of the detection layer 21A will be described hereinafter.

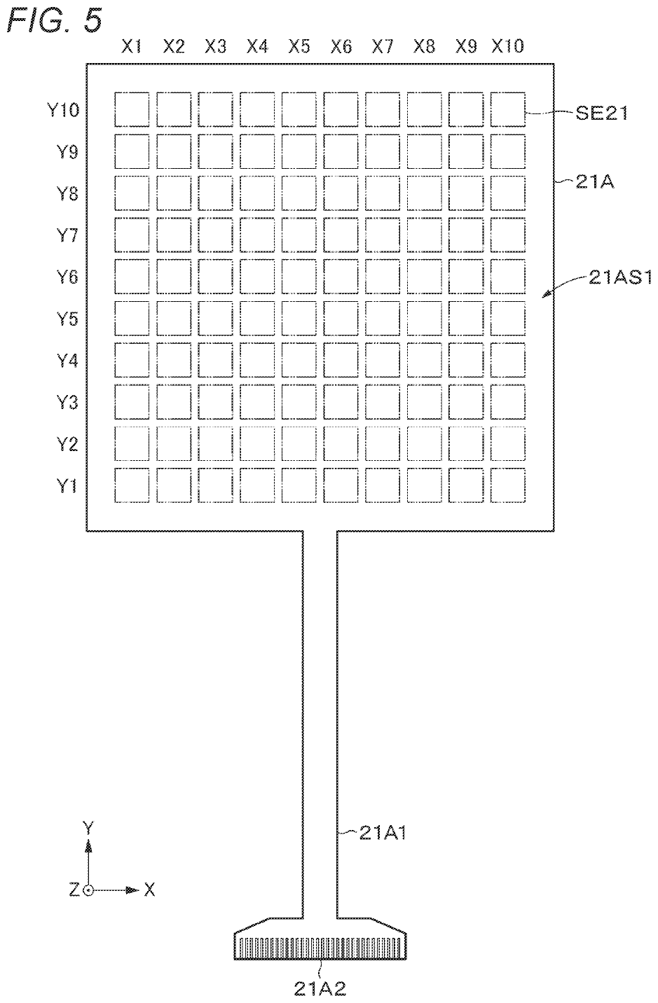

FIG. 5 is a plan view illustrating an example of the configuration of the detection layer 21A. The plurality of sensing units SE21 is arrayed in a matrix. The sensing unit SE21 has, for example, a square shape. However, the shape of the sensing unit SE21 is not particularly limited, and may be a circular shape, an elliptical shape, a polygonal shape other than the square shape, or the like.

Note that, in FIG. 5, reference signs X1 to X10 indicate center positions of the sensing units SE21 in the X-axis direction, and reference signs Y1 to Y10 indicate center positions of the sensing units SE21 in the Y-axis direction.

A connection portion 21A1 having a film shape extends from a part of a peripheral edge of the detection layer 21A. A plurality of connection terminals 21A2 for connection with another substrate and the like is provided at a distal end of the connection portion 21A1.

It is preferable that the detection layer 21A and the connection portion 21A1 be integrally configured by one flexible printed circuit (FPC). Since the detection layer 21A and the connection portion 21A1 are integrally configured in this manner, the number of components of the force sensor 20A can be reduced.

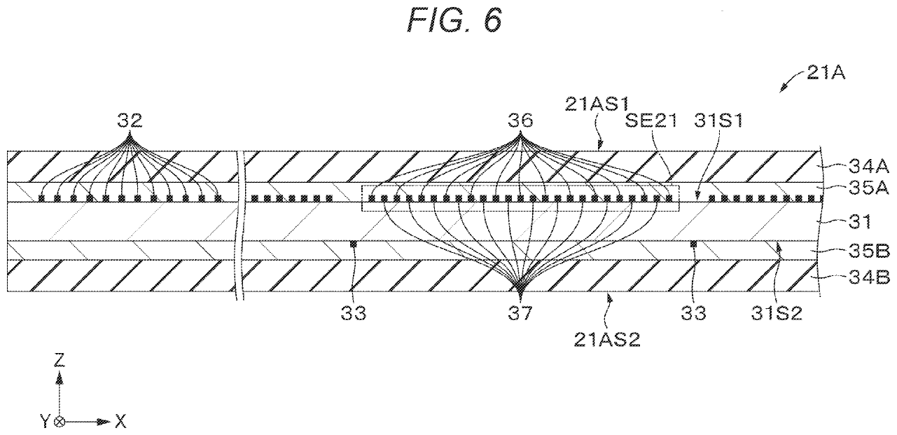

FIG. 6 is a cross-sectional view illustrating an example of the configuration of the detection layer 21A. The detection layer 21A includes a base member 31, the plurality of sensing units SE21, a plurality of routing wirings 32, a plurality of routing wirings 33, a coverlay film 34A, a coverlay film 34B, an adhesive layer 35A, and an adhesive layer 35B.

The base member 31 has a first surface 31S1 and a second surface 31S2 on the opposite side of the first surface 31S1. The plurality of sensing units SE21 and the plurality of routing wirings 32 are provided on the first surface 31S1 of the base member 31. The plurality of routing wirings 33 is provided on the second surface 31S2 of the base member. The coverlay film 34A is bonded to the first surface 31S1 of the base member 31 provided with the plurality of sensing units SE21 and the plurality of routing wirings 32 by the adhesive layer 35A. The coverlay film 34B is bonded to the second surface 31S2 of the base member 31 provided with the plurality of routing wirings 33 by the adhesive layer 35B.

The base member 31 has flexibility. The base member 31 has a film shape. The base member 31A includes a polymer resin. Examples of the polymer resin include polyethylene terephthalate (PET), polyethylene naphthalate (PEN), polycarbonate (PC), acrylic resin (PMMA) polyimide (PI), triacetyl cellulose (TAC), polyester, polyamide (PA), aramid, polyethylene (PE), polyacrylate, polyether sulfone, polysulfone, polypropylene (PP), cellulose diacetate, polyvinyl chloride, epoxy resin, urea resin, urethane resin, melamine resin, cyclic olefin polymer (COP), thermoplastic norbornene resin, and the like, for example, but are not limited to these polymer resins.

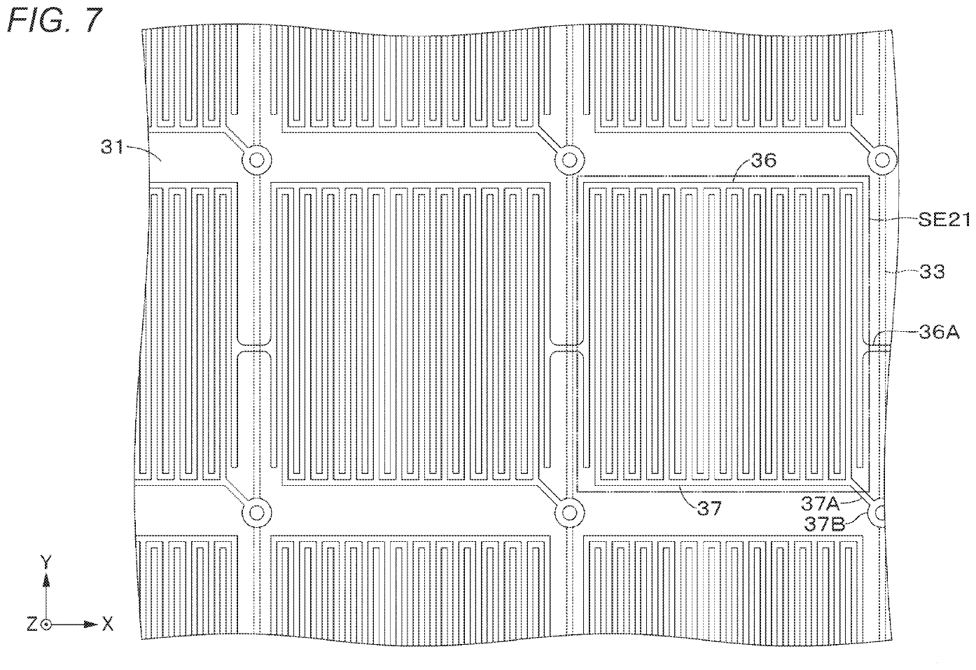

FIG. 7 is a plan view illustrating an example of a configuration of the sensing unit SE21. The sensing unit SE21 includes a sense electrode (reception electrode) 36 and a pulse electrode (transmission electrode) 37. The sense electrode 36 and the pulse electrode 37 are configured to be capable of forming capacitive coupling. More specifically, the sense electrode 36 and the pulse electrode 37 have comb-teeth shapes, and are arranged such that comb-teeth portions thereof mesh with each other.

The sense electrodes 36 adjacent to each other in the X-axis direction are connected to each other by a connection line 36A. Each of the pulse electrodes 37 is provided with a lead-out wiring 37A, and a distal end of the lead-out wiring 37A is connected to the routing wiring 33 via a through-hole 37B. The routing wiring 33 connects the pulse electrodes 37 adjacent to each other in the Y-axis direction.

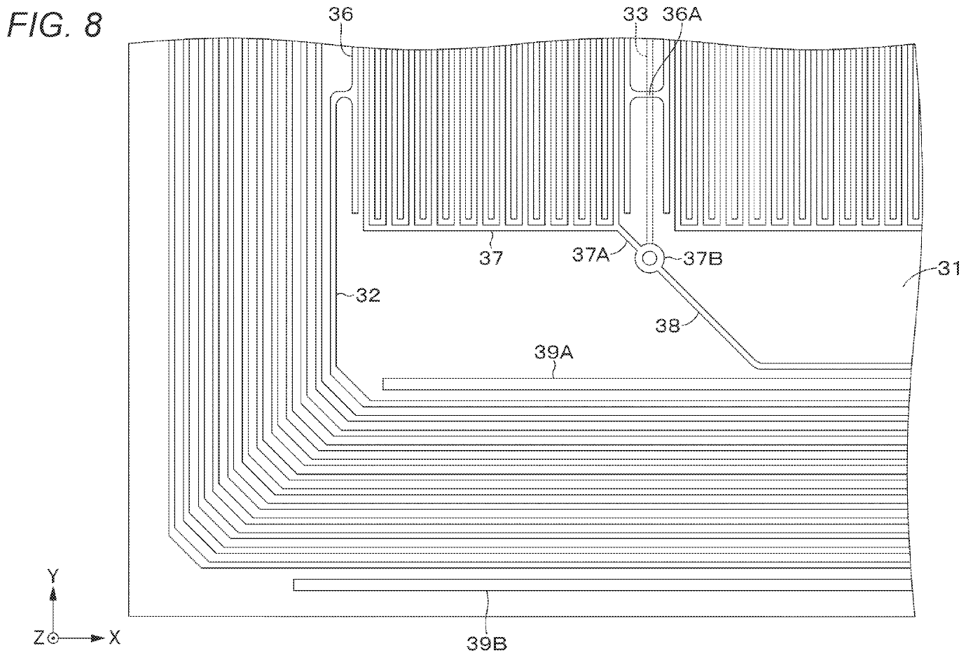

FIG. 8 is a plan view illustrating an example of an arrangement of the plurality of routing wirings 32 and the plurality of routing wirings 33. The routing wiring 32 is led out from the sense electrode 36 located at one end in the X-axis direction among the plurality of sense electrodes 36 connected by a plurality of the connection lines 36A. The plurality of routing wirings 32 is routed to a peripheral edge portion of the first surface 31S1 of the base member 31 and is connected to the connection terminals 21A2 through the connection portion 21A1.

The detection layer 21A further includes a plurality of routing wirings 38. The routing wirings 38 are connected to the lead-out wiring 37A led out from the pulse electrode 37 located at one end in the Y-axis direction among the plurality of pulse electrodes 37 connected by the routing wirings 33. The plurality of routing wirings 38 is routed to the peripheral edge portion of the first surface 31S1 of the base member 31 together with the plurality of routing wirings 32, and is connected to the connection terminals 21A2 through the connection portion 21A1.

The detection layer 21A further includes a ground electrode 39A and a ground electrode 39B. The ground electrode 39A and the ground electrode 39B are connected to a reference potential. The ground electrode 39A and the ground electrode 39B extend in parallel with the plurality of routing wirings 32. The plurality of routing wirings 32 is provided between the ground electrode 39A and the ground electrode 39B. Since the plurality of routing wirings 32 is provided between the ground electrode 39A and the ground electrode 39B in this manner, it is possible to suppress external noise (external electric field) from entering the plurality of routing wirings 32. Therefore, it is possible to suppress a decrease in detection accuracy or erroneous detection of the force sensor 20A due to the external noise.

### (Separation Layer)

The separation layer 22 separates the detection layer 21A and the detection layer 21B from each other. Therefore, electromagnetic interference between the detection layer 21A and the detection layer 21B can be suppressed. The separation layer 22 is configured to be elastically deformable in an in-plane direction of the sensing surface 20S by a shear force acting in the in-plane direction of the sensing surface 20S (that is, the in-plane direction of the force sensor 20A).

The separation layer 22 preferably contains gel. When containing the gel, the separation layer 22 is hardly crushed only by a pressure acting on the sensing surface 20S, and is easily elastically deformed by the shear force acting in the in-plane direction of the sensing surface 20S, whereby desirable characteristics as the separation layer 22 are obtained. The gel is, for example, at least one polymer gel selected from the group consisting of a silicone gel, a urethane gel, an acrylic gel, and a styrene gel. The separation layer 22 may be supported by a base member (not illustrated).

A 25% compression-load-deflection (CLD) value of the separation layer 22 is ten or more times a 25% CLD value of the deformable layer 23A, preferably thirty or more times the 25% CLD value of the deformable layer 23A, and more preferably fifty or more times the 25% CLD value of the deformable layer 23A. If the 25% CLD value of the separation layer 22 is ten or more times the 25% CLD value of the deformable layer 23A, the deformable layer 23A is sufficiently likely to be crushed as compared with the separation layer 22 when the pressure acts on the sensing surface 20S, and thus, the detection sensitivity of the sensing unit SE21 can be improved.

The 25% CLD value of the separation layer 22 is ten or more times a 25% CLD value of the deformable layer 23B, preferably thirty or more times the 25% CLD value of the deformable layer 23B, and more preferably fifty or more times the 25% CLD value of the deformable layer 23B. If the 25% CLD value of the separation layer 22 is ten or more times the 25% CLD value of the deformable layer 23B, the deformable layer 23B is sufficiently likely to be crushed as compared with the separation layer 22 when the pressure acts on the sensing surface 20S, and thus, the detection sensitivity of the sensing unit SE22 can be improved.

The 25% CLD value of the separation layer 22 is preferably 500 kPa or less. When the 25% CLD value exceeds 500 kPa, there is a possibility that it is difficult for the separation layer 22 to be elastically deformed in the in-plane direction of the sensing surface 20S by the shear force acting in the in-plane direction of the sensing surface 20S (that is, the in-plane direction of the force sensor 20A). Therefore, there is a possibility that the detection sensitivity of the shear force in the in-plane direction of the force sensor 20A decreases.

The 25% CLD values of the separation layer 22, the deformable layer 23A, and the deformable layer 23B are measured in accordance with JIS K 6254.

A thickness of the separation layer 22 is preferably twice or more a thickness of the deformable layer 23A, more preferably four or more times the thickness of the deformable layer 23A, and still more preferably eight or more times the thickness of the deformable layer 23A. When the thickness of the separation layer 22 is twice or more the thickness of the deformable layer 23A, in a case where the shear force acts in the in-plane direction of the sensing surface 20S, the separation layer 22 is sufficiently likely to be deformed in the in-plane direction of the sensing surface 20S as compared with the deformable layer 23A, and thus, the detection sensitivity of the shear force can be further improved.

The thickness of the separation layer 22 is preferably twice or more a thickness of the deformable layer 23B, more preferably four or more times the thickness of the deformable layer 23B, and still more preferably eight or more times the thickness of the deformable layer 23B. When the thickness of the separation layer 22 is twice or more the thickness of the deformable layer 23B, in a case where the shear force acts in the in-plane direction of the sensing surface 20S, the separation layer 22 is sufficiently likely to be deformed in the in-plane direction of the sensing surface 20S as compared with the deformable layer 23B, and thus, the detection sensitivity of the shear force can be further improved.

The thickness of the separation layer 22 is preferably 10,000 μm or less, and more preferably 4000 μm or less. If the thickness of the separation layer 22 exceeds 10,000 μm, there is a possibility that it becomes difficult to apply the force sensor 20A to an electronic device or the like.

The thicknesses of the separation layer 22, the deformable layer 23A, and the deformable layer 23B are obtained as follows. First, the force sensor 20A is processed by a focused ion beam (FIB) method or the like to prepare a cross section, and a cross-sectional image is captured using a scanning electron microscope (SEM). Next, the thicknesses of the separation layer 22, the deformable layer 23A, and the deformable layer 23B are measured using this cross-sectional image.

A basis weight of the separation layer 22 is preferably ten or more times a basis weight of the deformable layer 23A, and more preferably 25 or more times the basis weight of the deformable layer 23A. If the basis weight of the separation layer 22 is ten or more times the basis weight of the deformable layer 23A, the deformable layer 23A is sufficiently likely to be crushed as compared with the separation layer 22 when the pressure acts on the sensing surface 20S, and thus, the detection sensitivity of the sensing unit SE21 can be further improved.

The basis weight of the separation layer 22 is preferably ten or more times a basis weight of the deformable layer 23B, and more preferably 25 or more times the basis weight of the deformable layer 23B. If the basis weight of the separation layer 22 is ten or more times the basis weight of the deformable layer 23B, the deformable layer 23B is sufficiently likely to be crushed as compared with the separation layer 22 when the pressure acts on the sensing surface 20S, and thus, the detection sensitivity of the sensing unit SE22 can be further improved.

The basis weight of the separation layer 22 is preferably 1000 mg/cm² or less. When the basis weight exceeds 1000 mg/cm², there is a possibility that it is difficult for the separation layer 22 to be elastically deformed in the in-plane direction of the sensing surface 20S by the shear force acting in the in-plane direction of the sensing surface 20S (that is, the in-plane direction of the force sensor 20A). Therefore, there is a possibility that the detection sensitivity of the shear force in the in-plane direction of the force sensor 20A decreases.

The basis weight of the separation layer 22 is obtained as follows. First, the conductive layer 24A, the deformable layer 23A, and the detection layer 21A are peeled off from the force sensor 20A to expose the surface of the separation layer 22, and then a mass M1 of the force sensor 20A is measured in this state. Next, the separation layer 22 is removed by dissolving the separation layer 22 with a solvent or the like, and then a mass M2 of the force sensor 20A is measured in this state. Finally, the basis weight of the deformable layer 23 is obtained from the following formula.

Basis weight of separation layer 22 [mg/cm²]=(mass M1−mass M2)/(area S1 of separation layer 22)

The basis weight of the deformable layer 23A is obtained as follows. First, the conductive layer 24A is peeled off from the force sensor 20A to expose the surface of the deformable layer 23A, and then a mass M3 of the force sensor 20A is measured in this state. Next, the deformable layer 23A is removed by dissolving the deformable layer 23A with a solvent or the like, and then a mass M4 of the force sensor 20A is measured in this state. Finally, the basis weight of the deformable layer 23A is obtained from the following formula.

Basis weight of deformable layer 23A [mg/cm²]=(mass M3−mass M4)/(area S2 of deformable layer 23A)

The basis weight of the deformable layer 23B is obtained as follows. First, the conductive layer 24B is peeled off from the force sensor 20A to expose the surface of the deformable layer 23B, and then a mass M5 of the force sensor 20A is measured in this state. Next, the deformable layer 23B is removed by dissolving the deformable layer 23B with a solvent or the like, and then a mass M6 of the force sensor 20A is measured in this state. Finally, the basis weight of the deformable layer 23B is obtained from the following formula.

Basis weight of deformable layer 23B [mg/cm²]=(mass M5−mass M6)/(area S3 of deformable layer 23B)

### (Conductive Layer)

The conductive layer 24A has at least one of flexibility or stretchability. The conductive layer 24A is bent toward the detection layer 21A when a pressure acts on the sensing surface 20S. The conductive layer 24B may or does not necessarily have at least one of the flexibility or the stretchability, but preferably has the flexibility in order to enable the force sensor 20A to be mounted to a curved surface.

The conductive layer 24A has a first surface 24AS1 and a second surface 24AS2 opposite to the first surface 24AS1. The second surface 24AS2 opposes the first surface 21AS1 of the detection layer 21A. The conductive layer 24B has a first surface 24BS1 and a second surface 24BS2 on the opposite side of the first surface 24BS1. The first surface 24BS1 opposes the second surface 21BS2 of the detection layer 21B.

An elastic modulus of the conductive layer 24A is preferably 10 MPa or less. When the elastic modulus of the conductive layer 24A is 10 MPa or less, the flexibility of the conductive layer 24A is improved, and when the pressure acts on the sensing surface 20S, the pressure is easily transmitted to the detection layer 21B so that the detection layer 21B is easily deformed. Therefore, the detection sensitivity of the sensing unit SE22 can be improved. The elastic modulus described above is measured in accordance with JIS K 7161.

The conductive layer 24A and the conductive layer 24B are so-called grounded electrodes, and are connected to a reference potential. Examples of shapes of the conductive layer 24A and the conductive layer 24B include a thin film shape, a foil shape, a mesh shape, and the like, but are not limited to these shapes. Each of the conductive layer 24A and the conductive layer 24B may be supported by a base member (not illustrated).

Each of the conductive layers 24A and 24B is only required to have electric conductivity, and is, for example, an inorganic conductive layer including an inorganic conductive material, an organic conductive layer including an organic conductive material, an organic-inorganic conductive layer including both the inorganic conductive material and the organic conductive material, or the like. The inorganic conductive material and the organic conductive material may be particles. The conductive layers 24A and 24B may be conductive fabrics.

Examples of the inorganic conductive material include metal, a metal oxide, and the like. Here, it is defined that metal includes semi-metal. Examples of the metal includes metal such as aluminum, copper, silver, gold, platinum, palladium, nickel, tin, cobalt, rhodium, iridium, steel, ruthenium, osmium, manganese, molybdenum, tungsten, niobium, tantalum, titanium, bismuth, antimony, and lead, an alloy containing two or more of these types of metal, and the like, but are not limited to these types of metal. Specific examples of the alloy include, but are not limited to, stainless steel. Examples of the metal oxide include an indium tin oxide (ITO), a zinc oxide, an indium oxide, an antimony-added tin oxide, a fluorine-added tin oxide, an aluminum-added zinc oxide, a gallium-added zinc oxide, a silicon-added zinc oxide, a zinc oxide-tin oxide system, an indium oxide-tin oxide system, a zinc oxide-indium oxide-magnesium oxide system, and the like, but are not limited to these metal oxides.

Examples of the organic conductive material include a carbon material, a conductive polymer, and the like. Examples of the carbon material include carbon black, a carbon fiber, fullerene, graphene, a carbon nanotube, a carbon micro coil, nanohorn, and the like, but are not limited to these carbon materials. As the conductive polymer, for example, substituted or non-substituted polyaniline, polypyrrole, polythiophene, or the like can be used, but the invention is not limited to these conductive polymers.

The conductive layers 24A and 24B may be thin films prepared by either a dry process or a wet process. As the dry process, for example, a sputtering method, a vapor deposition method, or the like can be used, but the invention is not particularly limited thereto.

Since the conductive layers 24A and 24B are provided on both the surfaces of the force sensor 20A, it is possible to suppress the entry of the external noise (external electric field) into the force sensor 20A from both main surface sides of the force sensor 20A. Therefore, it is possible to suppress a decrease in detection accuracy or erroneous detection of the force sensor 20A due to the external noise.

### (Deformable Layer)

The deformable layer 23A separates the detection layer 21A and the conductive layer 24A such that the detection layer 21A and the conductive layer 24A are parallel. The sensitivity and a dynamic range of the sensing unit SE21 can be adjusted by the thickness of the deformable layer 23A. The deformable layer 23A is configured to be elastically deformable in response to the pressure acting on the sensing surface 20S, that is, the pressure acting in the thickness direction of the force sensor 20A. The deformable layer 23A may be supported by a base member (not illustrated).

The deformable layer 23B separates the detection layer 21B and the conductive layer 24B such that the detection layer 21B and the conductive layer 24B are parallel. The sensitivity and a dynamic range of the sensing unit SE22 can be adjusted by the thickness of the deformable layer 23B. The deformable layer 23B is configured to be elastically deformable in response to the pressure acting on the sensing surface 20S, that is, the pressure acting in the thickness direction of the force sensor 20A. The deformable layer 23A may be supported by a base member (not illustrated).

The 25% CLD values of the deformable layer 23A and the deformable layer 23B may be the same or substantially the same. The deformable layers 23A and 23B contain, for example, a foamed resin or an insulating elastomer. The foamed resin is a so-called sponge, and is, for example, at least one of foamed polyurethane (polyurethane foam), foamed polyethylene (polyethylene foam), foamed polyolefin (polyolefin foam), foamed acrylic (acrylic foam), sponge rubber, or the like. The insulating elastomer is, for example, at least one of a silicone-based elastomer, an acrylic-based elastomer, a urethane-based elastomer, a styrene-based elastomer, or the like.

### (Adhesive Layer)

The adhesive layer includes, for example, an adhesive or a double-sided adhesive film having insulating properties. As the adhesive, for example, at least one of an acrylic-based adhesive, a silicone-based adhesive, or a urethane-based adhesive can be used. Note that pressure sensitive adhesion is defined as a type of adhesion in the present disclosure. According to this definition, a pressure sensitive layer is regarded as a type of adhesive layer.

### [Operation of Force Sensor]

### (Operation of Force Sensor at Time of Pressure Detection)

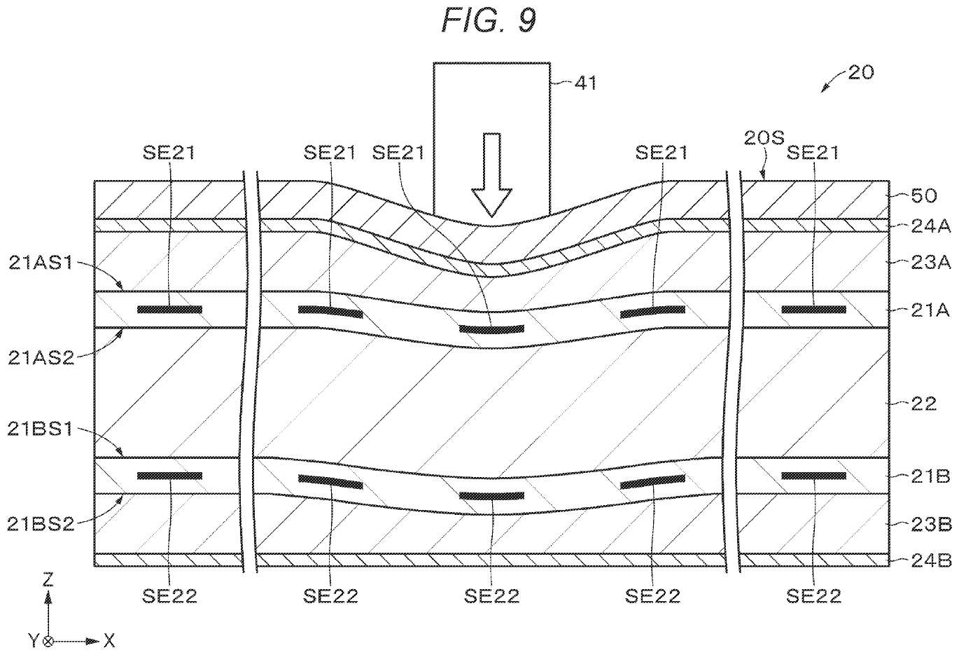

FIG. 9 is a cross-sectional view for describing an example of an operation of the force sensor 20A at the time of pressure detection. When the sensing surface 20S is pressed by an object 41 and a pressure acts on the sensing surface 20S, the conductive layer 24A is bent toward the detection layer 21A with a pressure action point as the center and pushes and crushes a part of the deformable layer 23A. Therefore, the conductive layer 24A and a part of the detection layer 21A come close to each other. As a result, some of lines of electric force of the plurality of sensing units SE21 included in a portion, which comes close to the conductive layer 24A (that is, some of lines of electric force between the sense electrodes 36 and the pulse electrodes 37) of the detection layer 21A flow to the conductive layer 24A so that capacitances of the plurality of sensing units SE21 change.

Furthermore, the pressure acts on the first surface 21AS1 of the detection layer 21A by a part of the deformable layer 23A pushed and crushed as described above, and the detection layer 21A, the separation layer 22, and the detection layer 21B are bent toward the conductive layer 24B with the pressure action point as the center. Therefore, the detection layer 21B and a part of the conductive layer 24B come close to each other. As a result, some of lines of electric force of the plurality of sensing units SE22 included in a portion, which comes close to the conductive layer 24B (that is, some of lines of electric force between the sense electrodes 36 and the pulse electrodes 37) of the detection layer 21B flow to the conductive layer 24B so that capacitances of the plurality of sensing units SE22 change.

The sensor IC 4A sequentially scans the plurality of sensing units SE21 included in the detection layer 21A, and acquires an output signal distribution, that is, a capacitance distribution from the plurality of sensing units SE21. Similarly, the sensor IC 4A sequentially scans the plurality of sensing units SE22 included in the detection layer 21B, and acquires an output signal distribution, that is, a capacitance distribution from the plurality of sensing units SE21. The sensor IC 4A outputs the acquired output signal distribution to the control unit 3.

The control unit 3 computes magnitude of the pressure and an acting position of the pressure on the basis of the output signal distribution received from the detection layer 21A via the sensor IC 4A. The reason why the magnitude of the pressure and the acting position of the pressure are computed on the basis of the output signal distribution from the detection layer 21A is that the detection layer 21A is closer to the sensing surface 20S and has higher detection sensitivity as compared with the detection layer 21B. However, the control unit 3 may compute the magnitude of the pressure and the acting position of the pressure on the basis of the output signal distribution received from the detection layer 21B via the sensor IC 4A, or may compute the magnitude of the pressure and the acting position of the pressure on the basis of the output signal distributions received from the detection layer 21A and the detection layer 21B via the sensor IC 4A.

### (Operation of Force Sensor at Time of Shear Force Detection)

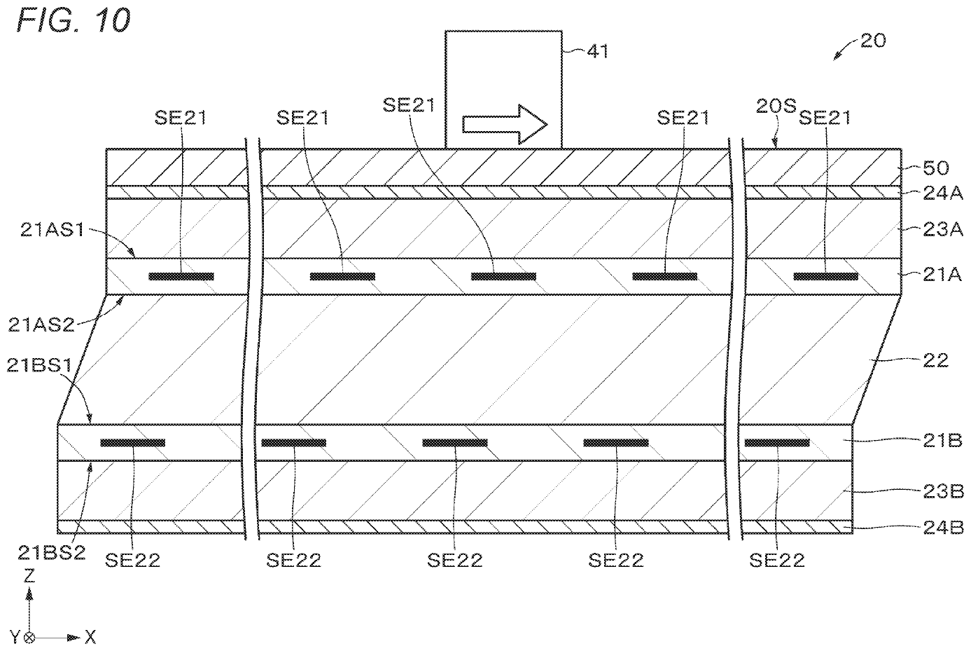

FIG. 10 is a cross-sectional view for describing an example of an operation of the force sensor 20A at the time of shear force detection. When the object 41 moves in the in-plane direction of the sensing surface 20S and a shear force acts on the force sensor 20A, the separation layer 22 is elastically deformed in the in-plane direction of the force sensor 20A, and relative positions of the detection layer 21A and the detection layer 21B in the in-plane direction (X and Y directions) of the force sensor 20A are shifted. That is, relative positions of the sensing unit SE21 and the sensing unit SE22 in the in-plane direction of the force sensor 20A are shifted. Therefore, a center-of-gravity position of the output signal distribution (capacitance distribution) of the detection layer 21A and a center-of-gravity position of the output signal distribution (capacitance distribution) of the detection layer 21B are shifted in the in-plane direction (X and Y directions) of the force sensor 20A. Note that it is necessary that a pressure acts on the sensing surface 20S due to the object 41 in order to detect the shear force, but deformation of each layer of the force sensor 20A due to this pressure is omitted in FIG. 10.

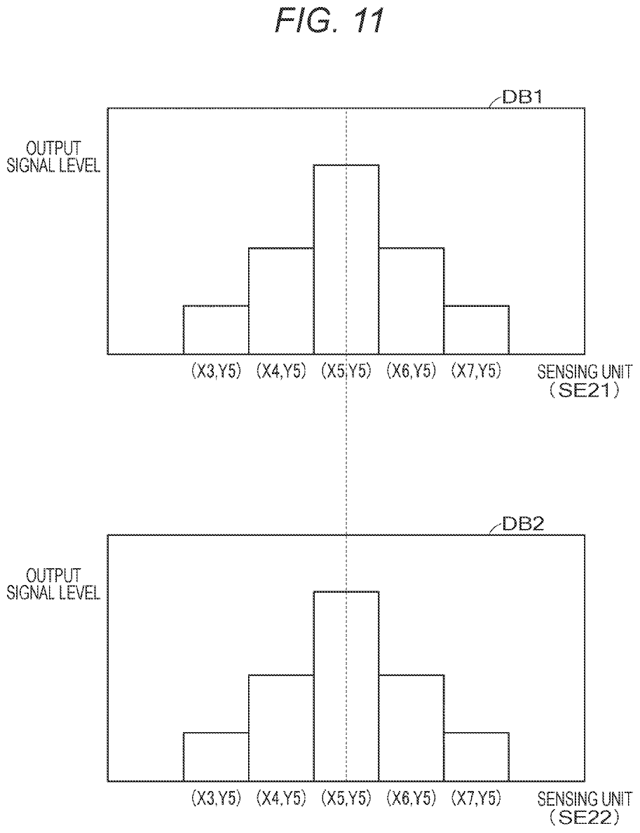

FIG. 11 is a graph illustrating examples of an output signal distribution DB1 of the detection layer 21A and an output signal distribution DB2 of the detection layer 21B in a state where only a pressure acts on the force sensor 20A. The output signal distribution DB1 and the output signal distribution DB2 correspond to capacitance distributions (pressure distributions). In the state where only the pressure acts on the force sensor 20A, center-of-gravity positions of the output signal distribution DB1 of the detection layer 21A and the output signal distribution DB2 of the detection layer 21B coincide with each other.

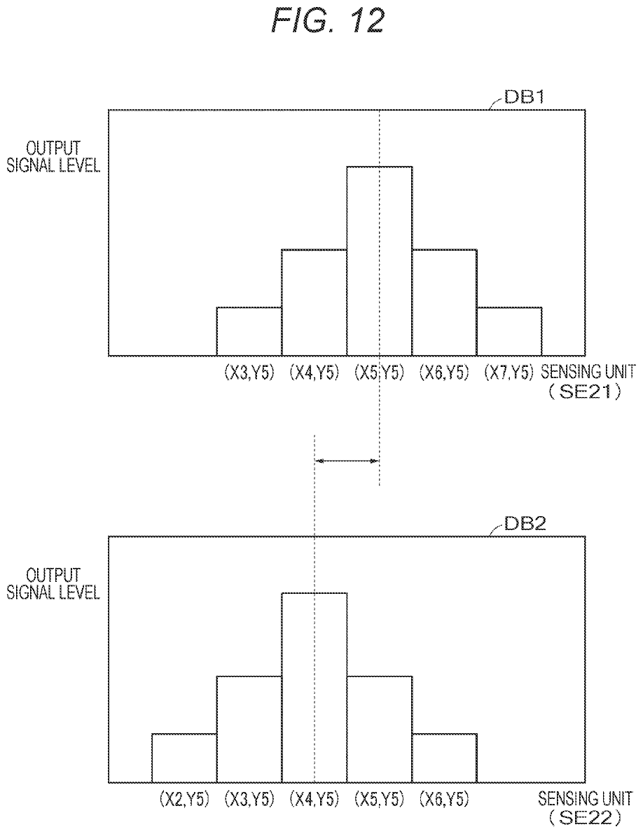

FIG. 12 is a graph illustrating examples of the output signal distribution DB1 of the detection layer 21A and the output signal distribution DB2 of the detection layer 21B in a state where a shear force acts on the force sensor 20A. In the state where the shear force acts on the force sensor 20A, the center-of-gravity positions of the output signal distribution DB1 of the detection layer 21A and the output signal distribution DB2 of the detection layer 21B are shifted.

The control unit 3 calculates a three-axis force on the basis of the output signal distribution of the detection layer 21A and the output signal distribution of the detection layer 21B which are output from the sensor IC 4A. More specifically, the control unit 3 calculates a center-of-gravity position of the pressure in the detection layer 21A from the output signal distribution DB1 of the detection layer 21A, and calculates a center-of-gravity position of the pressure in the detection layer 21B from the output signal distribution DB2 of the detection layer 21B. The control unit 3 calculates magnitude and a direction of the shear force from a difference between the center-of-gravity position of the pressure in the detection layer 21A and the center-of-gravity position of the pressure in the detection layer 21B.

### [Prescribed Friction Coefficient Used in Robot System]

In the present embodiment, a prescribed friction coefficient is stored in the storage device 3A in advance. The prescribed friction coefficient is used to control a gripping force of the robot hand 12. The prescribed friction coefficient is a friction coefficient for stably gripping a workpiece by the robot hand 12, and is smaller than a static friction coefficient between each of the contact regions 122AS and 122BS of the robot hand 12 (that is, the gripping surfaces of the robot hand 12) and the workpiece.

In a case where the robot hand 12 is used to grip a plurality of types of workpieces, the prescribed friction coefficient is set as follows, for example. For each of the plurality of types of workpieces assumed to be gripped by the robot hand 12, a static friction coefficient between each of the contact regions 122AS and 122BS of the robot hand 12 and the workpiece is measured. Among the static friction coefficients measured for the respective workpieces, a value smaller than a minimum static friction coefficient is set as the prescribed friction coefficient.

In a case where the robot hand 12 is used to grip one type of workpiece, the prescribed friction coefficient is set as follows, for example. For one type of workpiece assumed to be gripped by the robot hand 12, a static friction coefficient between each of the contact regions 122AS and 122BS of the robot hand 12 and the workpiece is measured. A value smaller than the measured static friction coefficient is set as the prescribed friction coefficient.

The prescribed static friction coefficient is stored in, for example, the storage device 3A included in the control unit 3. Note that the robot control device 1 may transmit an identifier (ID) of the articulated robot 10 and a type of a workpiece to a server or the like, receive a prescribed friction coefficient corresponding to the ID of the articulated robot 10 and the type of the workpiece from the server, and store the prescribed friction coefficient in the storage device 3A.

### [Operation Performed by Robot System]

### (Operation of Stably Gripping Workpiece)

Next, an example of an operation performed in the robot system according to the present embodiment will be described. First, an operation of stably gripping a workpiece will be described.

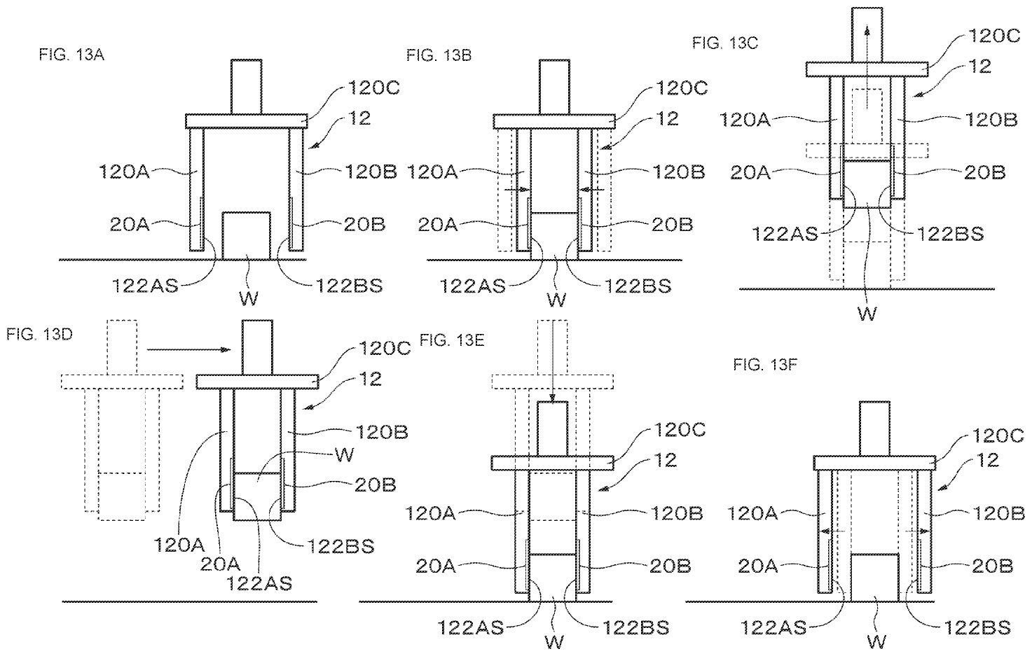

FIG. 13A schematically illustrates the robot hand 12 in a state where no workpiece (hereinafter, also referred to as workpiece W as appropriate) is gripped. As illustrated in FIG. 13B, the workpiece W is gripped as the finger portions 120A and 120B of the robot hand 12 sandwich the workpiece W. Then, after the workpiece W is lifted as illustrated in FIG. 13C, the workpiece W is moved in the horizontal direction as illustrated in FIG. 13D. Then, the robot hand 12 stopped at a predetermined position descends as illustrated in FIG. 13E, and the gripping of the workpiece W by the robot hand 12 is released after the workpiece W is placed on a table as illustrated in FIG. 13F.

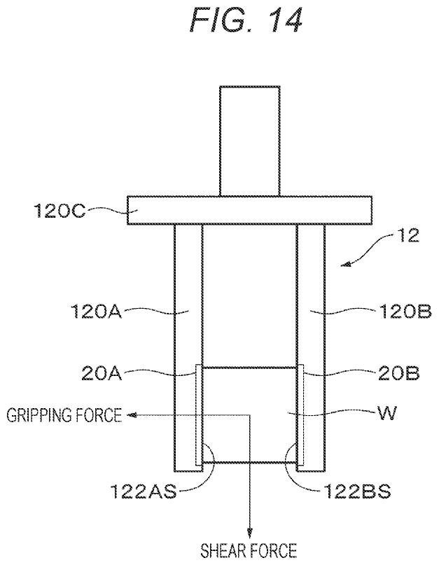

FIG. 14 is a view schematically illustrating a shear force and a gripping force at the time of gripping the workpiece W. As illustrated in FIG. 14, the shear force acting on the contact regions 122AS and 122BS and the gripping force by the finger portions 120A and 120B are substantially orthogonal to each other in an example in which the robot hand 12 lifts the workpiece W.

The control unit 3 controls the gripping force of the robot hand 12 on the basis of the following Formula (1).

$$Gripping force = shear force / friction coefficient μ \qquad ( 1 )$$

Here, in Formula (1), the shear force is a shear force detected by the force sensor 20A or the force sensor 20B. Furthermore, the friction coefficient μ is the prescribed friction coefficient described above, and is stored in the storage device 3A.

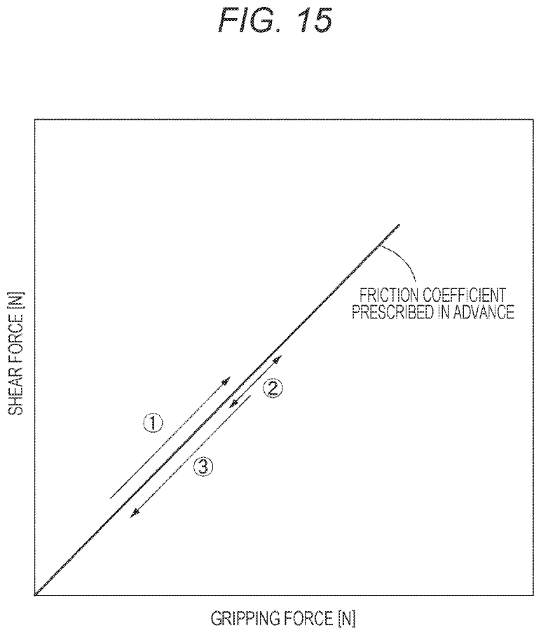

FIG. 15 illustrates Formula (1) expressed in a graph.

The friction coefficient μ is set to a value smaller than a static friction coefficient μ₀ between each of the contact regions 122AS and 122BS of the robot hand 12 and the workpiece. There are a case where the gripping force of the robot hand 12 is controlled by the following Formula (2) using the static friction coefficient μ₀, a case where a deviation occurs between the gripping force calculated by the following Formula (2) and an actual gripping force of the robot hand 12, and a case where the workpiece cannot be stably gripped by the robot hand 12.

$$Gripping force = shear force / static friction coefficient {μ}_{0} \qquad ( 2 )$$

In the present embodiment, since the friction coefficient μ is set to the value smaller than the static friction coefficient μ₀ as described above, the workpiece can be stably gripped by the robot hand 12 even in the case where the deviation occurs between the gripping force calculated by Formula (1) and the actual gripping force of the robot hand 12.

When the robot hand 12 lifts the workpiece W, the shear force acting on the contact regions 122AS and 122BS increases (circled “1” in FIG. 15). The control unit 3 reads the prescribed friction coefficient from the storage device 3A, and calculates the gripping force (gripping force by which the workpiece W can be stably gripped) by dividing the shear force by the read prescribed friction coefficient. Then, the control unit 3 outputs a control signal for driving the drive units 125A and 125B so as to obtain the calculated gripping force. Therefore, the robot hand 12 is driven so as to have the gripping force corresponding to the increased shear force.

When the workpiece W is moved horizontally, the shear force increases or decreases (circled “2” in FIG. 15) since acceleration changes. Also in this case, control is performed to obtain a gripping force corresponding to the changed shear force. Note that it may be configured not to perform control for changing the gripping force in a case where the change in the shear force does not exceed a certain value.

In order for the robot hand 12 to place the workpiece W, the shear force decreases (circled “3” in FIG. 15). The control unit 3 calculates a gripping force corresponding to the decreased shear force using the friction coefficient. Then, the control unit 3 outputs a control signal for driving the drive units 125A and 125B so as to obtain the calculated gripping force. Therefore, the robot hand 12 is driven so as to have the gripping force corresponding to the decreased shear force. Finally, since the shear force becomes zero, the gripping force is also zero, that is, a gripping state of the workpiece W by the finger portions 120A and 120B is released.

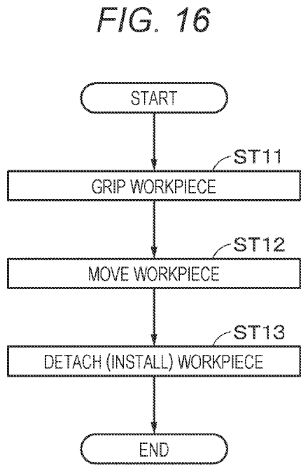

FIG. 16 is a flowchart illustrating the overall flow of an operation performed by the control unit 3. In step ST11, the robot hand 12 of the articulated robot 10 grips the workpiece W. In subsequent step ST12, the workpiece W is moved. Then, in subsequent step ST13, the workpiece W is detached from the robot hand 12 and installed at an appropriate point.

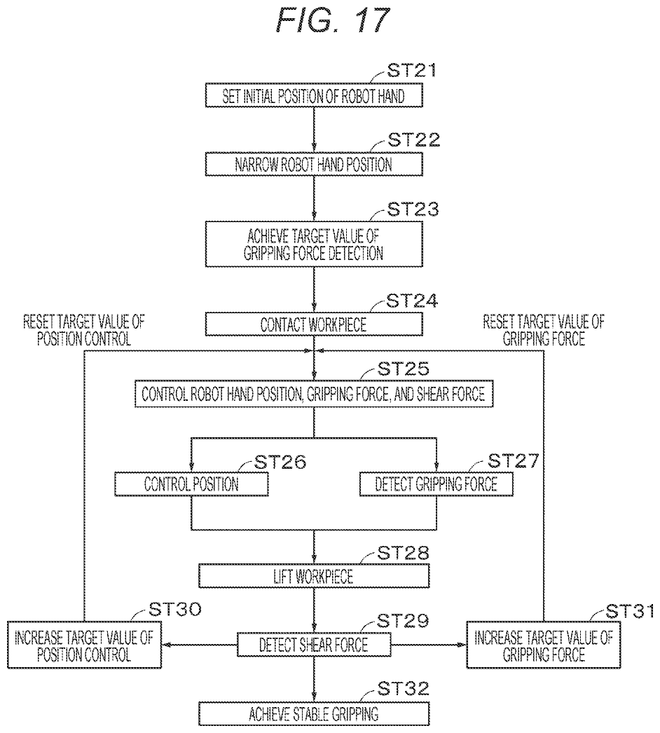

FIG. 17 is a flowchart illustrating a flow of processing when the workpiece W is gripped and lifted. Note that the processing to be described hereinafter is performed by the robot control device 1 (specific control unit 3), and is implemented as a target drive unit is driven according to a control signal output from the control unit 3. The same applies to processing illustrated in the other flowcharts.

In step ST21, an initial position of the robot hand 12 is set. The initial position of the robot hand 12 is, for example, a position where the workpiece W is arranged. Then, the processing proceeds to step ST22.

In step ST22, the robot hand 12 is driven to be located at the initial position set in step ST21. Specifically, a width between the finger portions 120A and 120B is narrowed. Then, the processing proceeds to step ST23.

In step ST23, the finger portions 120A and 120B are driven to have a preset value (target value) of a gripping force. Therefore, the target value of the gripping force is achieved. Therefore, the workpiece W and the robot hand 12 come into contact with each other in step ST24. Then, the processing proceeds to step ST25.

In step ST25, a position, the gripping force, and a shear force of the robot hand 12 are controlled. For example, in step ST26, position control is performed on the robot hand 12 such that the robot hand 12 is located at a predetermined position. Furthermore, in step ST27, the gripping force corresponding to the shear force is detected. Then, the processing proceeds to step ST28.

In step ST28, the drive units 114, 114B, 114C, 114D, and the like are driven according to the control of the control unit 3, whereby the workpiece W is lifted. Then, the processing proceeds to step ST29.

In step ST29, a shear force in a state where the workpiece W is lifted is detected. A gripping force corresponding to the detected shear force is calculated on the basis of the detected shear force and the prescribed friction coefficient. Specifically, the shear force increases (circled “1” in FIG. 15), a target value is reset so as to increase the target value of the gripping force in order to stably grip the workpiece W (step ST31). Furthermore, a target value is reset so as to increase the target value for moving the robot hand 12 upward, that is, the target value of position control (step ST30). These processes are repeatedly performed with a predetermined resolution (for example, for each predetermined position).

The processes from step ST25 to step ST31 is repeated until the robot hand 12 reaches a prescribed position and the operation of lifting the workpiece W ends. Therefore, stable gripping is achieved in the operation of lifting the workpiece W (step ST32).

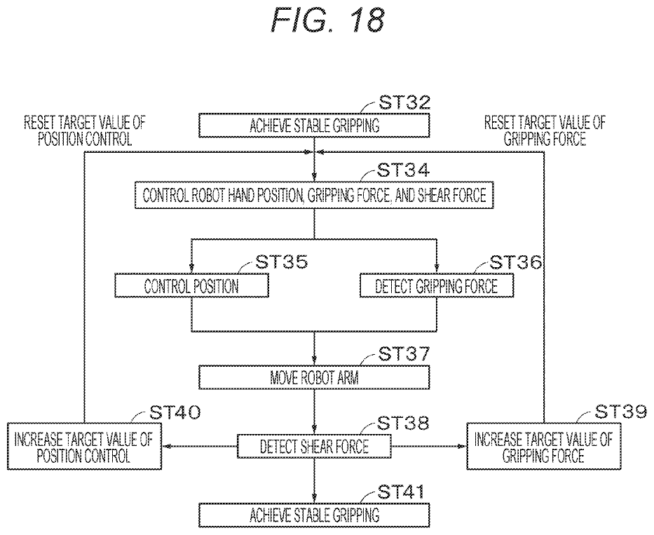

FIG. 18 is a flowchart illustrating a flow of processing when an operation of moving the workpiece W is performed. In step ST32, the stable gripping of the workpiece W is achieved as described above. Subsequent steps ST34 to ST36 are the same as the processes according to steps ST25 to ST27 described above, and thus, redundant description will be omitted.

In step ST37, control is performed to move the robot arm 11 so as to move the robot hand 12 stably griping the workpiece W. The acceleration is generated along with the movement of the robot arm 11 according to the control, and the shear force changes according to the acceleration. In step ST38, the changed shear force is detected. A target value of the gripping force is reset to obtain the gripping force in accordance with the detected shear force (step ST39). Furthermore, a target value of position control for the next position is reset (step ST38). Then, the gripping force corresponding to the changed shear force is obtained so that the gripping of the workpiece W is stable even during the movement of the workpiece W (step ST41).

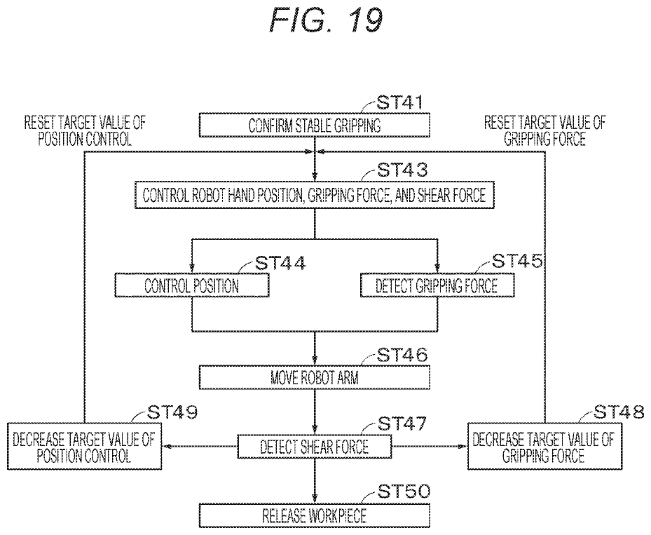

FIG. 19 is a flowchart illustrating a flow of processing when an operation of installing the workpiece W is performed. In step ST41, stable gripping of the workpiece W is achieved as described above. Subsequent steps ST43 to ST45 are the same as the processes according to steps ST34 to ST36 described above, and thus, redundant description will be omitted.

In step ST46, control is performed to move the robot arm 11 so as to install the workpiece W. The shear force changes with the movement of the robot arm 11 according to the control. In step ST47, the changed shear force is detected. A target value of the gripping force is reset to obtain the gripping force in accordance with the detected shear force (step ST48). Specifically, the target value of the gripping force is decreased since the shear force becomes smaller. Furthermore, a target value of position control is reset so as to lower the robot arm 11, that is, so as to lower the target value of the position control (step ST49). Then, since the shear force finally becomes zero or near zero, the gripping force is also set to zero so that the workpiece W is released from the robot hand 12 (step ST50).

### (Operation of Re-Holding Workpiece)

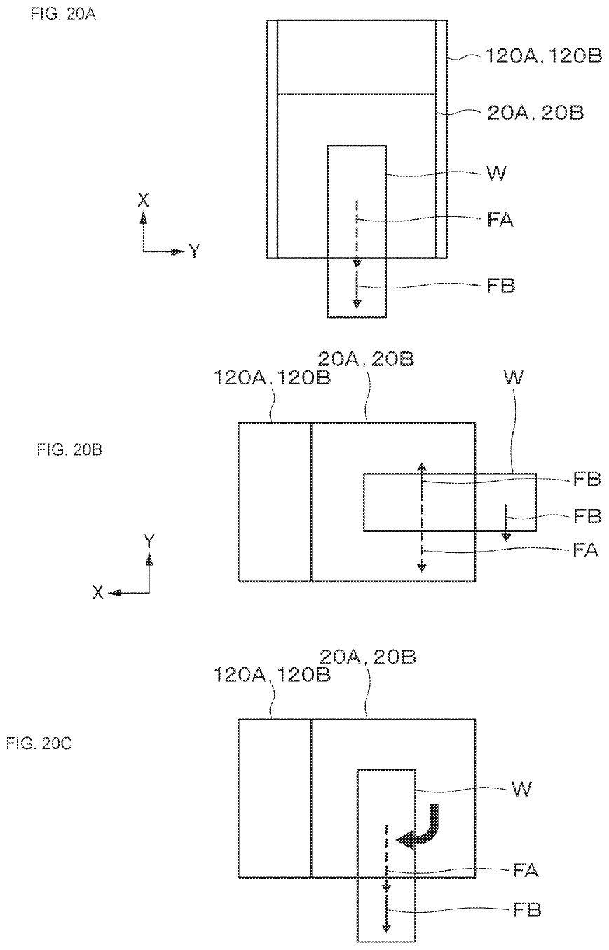

Next, an operation of re-holding the workpiece W will be described. FIG. 20A illustrates a state in which the workpiece W is gripped. Here, an example in which a part of the workpiece W is located outside the robot hand 12 will be described. In the state illustrated in FIG. 20A, a shear force (FA+FB) acts on the contact regions 122AS and 122BS. A direction of the robot hand 12 is changed from the state illustrated in FIG. 20A. For example, the robot hand 12 is rotated by 90 degrees to change the direction of the robot hand 12 from the vertical direction to the horizontal direction. After the rotation, a downward force FB is applied to the workpiece W located outside the workpiece W. On the other hand, a force FB in a direction opposite to the downward force FB described above is applied to the contact regions 122AS and 122BS of the robot hand 12 by the leverage principle. Therefore, the shear force (shear force detected in a state illustrated in FIG. 20B) acting on the contact regions 122AS and 122BS of the robot hand 12 decreases to be (FA−FB) as illustrated in FIG. 20B. After the rotation, the control unit 3 controls the robot hand 12 to gradually decrease a gripping force of the robot hand 12 to a prescribed gripping force. When the gripping force is decreased to the prescribed gripping force, a direction of the workpiece W changes from the state illustrated in FIG. 20B. For example, the workpiece W rotates by 90 degrees, and the direction of the workpiece W changes from the horizontal direction to the vertical direction. Therefore, a state illustrated in FIG. 20C is obtained. The shear force in the state illustrated in FIG. 20C is (FA+FB), which is substantially the same as the shear force in the state illustrated in FIG. 20A. Therefore, the control unit 3 resets a gripping force so as to correspond to the increased shear force, thereby achieving stable gripping of the workpiece W, in other words, re-holding of the workpiece W in the state illustrated in FIG. 20C.

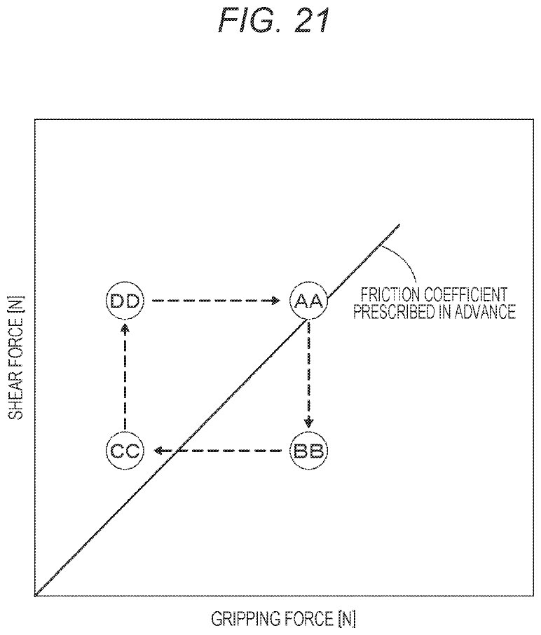

FIG. 21 is a graph illustrating changes in the shear force and the gripping force in the operation of re-holding the workpiece W. A point of the shear force and the gripping force in the state illustrated in FIG. 20A described above is point AA in FIG. 21. When the robot hand 12 rotates, the shear force acting on the contact regions 122AS and 122BS of the robot hand 12 decreases (AA→BB in FIG. 21). A gripping force is reset on the basis of the decreased shear force and the prescribed friction coefficient. Specifically, the gripping force is reset to a prescribed gripping force smaller than the gripping force in the state illustrated in FIG. 20A (BB→CC in FIG. 21). As the control unit 3 gradually decrease the gripping force toward the prescribed gripping force, the workpiece W rotates as illustrated in FIG. 20C. As the workpiece W rotates, the shear force applied to the contact regions 122AS and 122BS of the robot hand 12 increases (CC→DD in FIG. 21). In other words, the shear force becomes the same as the shear force before the change which is illustrated in FIG. 20A. The control unit 3 resets a gripping force on the basis of the increased shear force and the prescribed friction coefficient (DD→AA in FIG. 21). Therefore, it becomes possible to stably grip the rotated workpiece W.

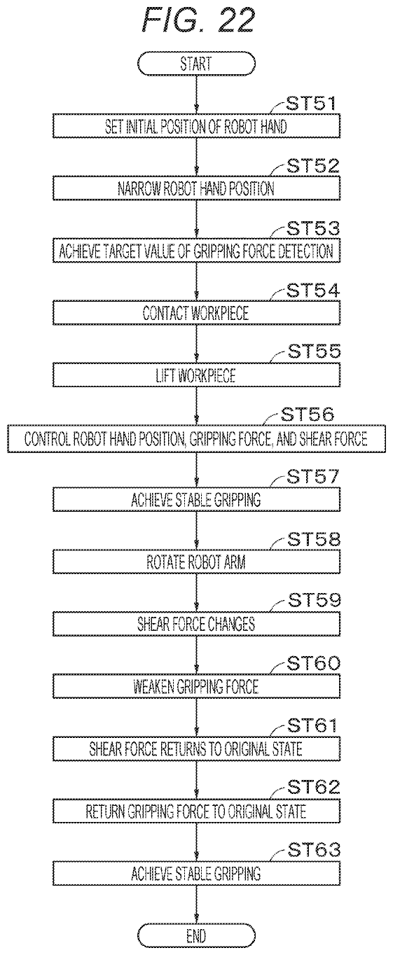

FIG. 22 is a flowchart illustrating a flow of processing performed in the operation of re-holding the workpiece W. Since the processing from steps ST51 to ST57 is similar to the above-described processing for stably gripping the workpiece W (for example, the processing illustrated in FIG. 17), redundant description will be omitted.

In step ST58 subsequent to step ST57, the robot arm 11 rotates. When the robot arm 11 rotates, the shear force changes. For example, in the examples illustrated in FIGS. 20A to 20B, the shear force becomes smaller (step ST59).

Since the shear force becomes smaller, the control unit 3 performs control to decrease the gripping force (step ST60). When the gripping force gradually decreases to be weakened to the prescribed gripping force, the workpiece W rotates. Therefore, a direction of the workpiece W becomes the same as a direction in step ST57, so that the shear force acting on the contact regions 122AS and 122BS returns to the original state (step ST61). Since the shear force returns to the original state, the gripping force returns to the original state (step ST62). Therefore, the stable gripping of the workpiece W is achieved (step ST63). In other words, the workpiece W can be re-held.

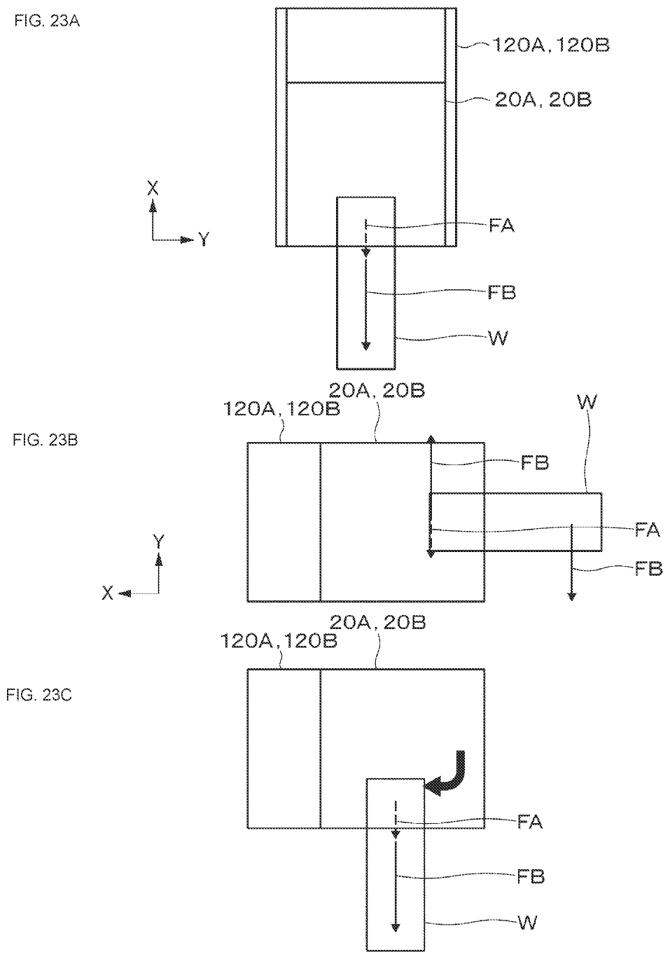

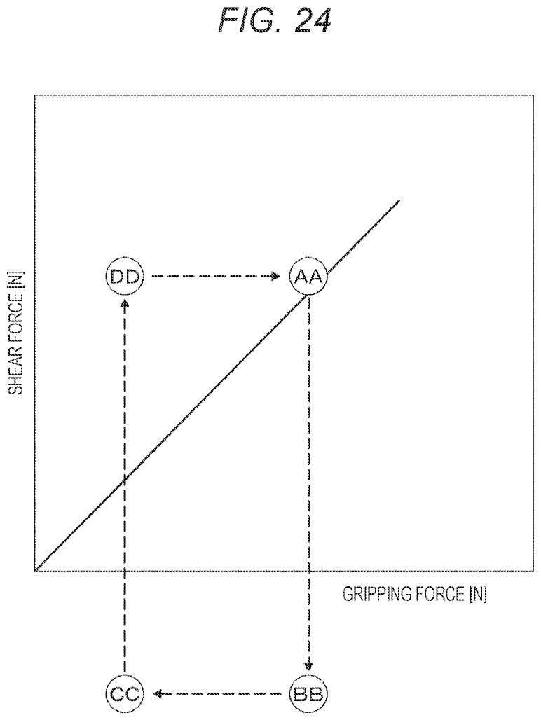

Note that there may be a case where an end portion of the workpiece W is gripped as illustrated in FIGS. 23A to 23C. In this case, an upward force becomes larger as illustrated in FIG. 23B, so that there may be a case where a shear force becomes a negative value. Also in this case, however, only the value of the shear force becomes negative as illustrated in FIG. 24, and control similar to the control illustrated in the flowchart of FIG. 22 is performed as the control.

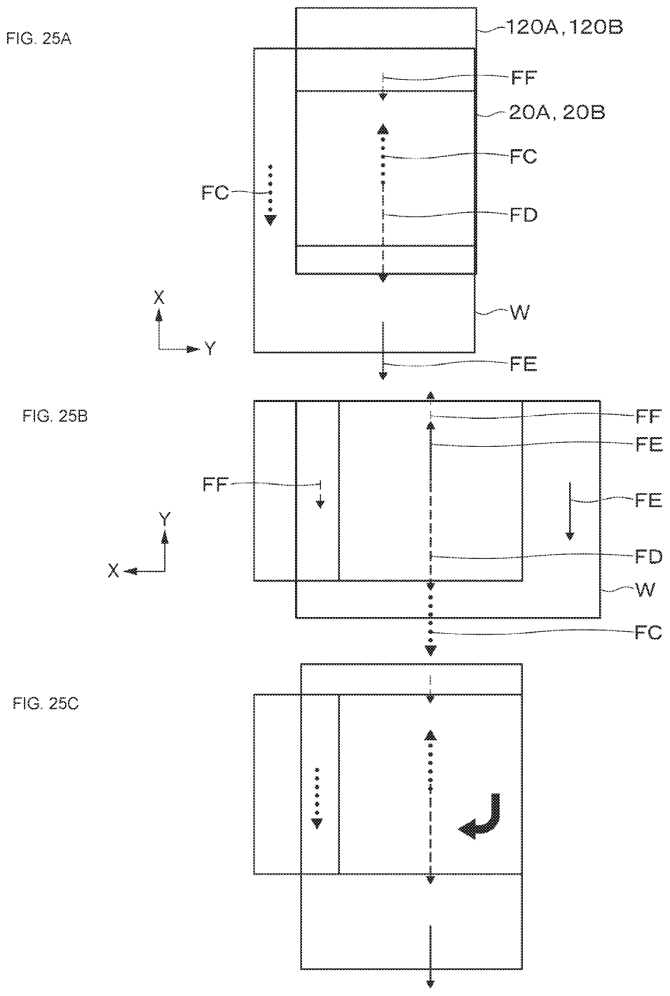

Furthermore, there is a case where the workpiece W is larger than the robot hand 12. Also in this case, similar control is performed. In a case where the workpiece W is larger than the finger portions 120A and 120B (specifically, the force sensors 20A and 20B) of the robot hand 12, as illustrated in FIG. 25A, forces FC, FD, FE, and FE are applied downward (−X direction), a force (−FC) is applied upward (+X direction), and a shear force acting on the contact regions 122AS and 122BS is the sum of these forces. When the robot hand 12 rotates, a force FF and a force FE are applied in the +Y direction, a force FC and a force FD are applied downward (−Y direction), and a shear force acting on the contact regions 122AS and 122BS is the sum of these forces. In other words, the shear force is smaller than the shear force in the state illustrated in FIG. 25A. A gripping force is weakened to correspond to the decreased shear force. When the gripping force is weakened, the workpiece W rotates as illustrated in FIG. 25C. When the workpiece W rotates, a shear force similar to the shear force in the state illustrated in FIG. 25A is obtained. Therefore, control for increasing the gripping force is performed, whereby the workpiece W can be stably gripped in the state illustrated in FIG. 25C. That is, even in a case where the workpiece W is larger than the finger portions 120A and 120B, the workpiece W can be re-held by performing the similar control.

### MODIFIED EXAMPLES

Although the example in which the present disclosure is applied to the vertical articulated robot has been described in the embodiment described above, a robot to which the present disclosure can be applied is not limited to this example. For example, the present disclosure can also be applied to a dual arm robot, a parallel sink robot, and the like.

A method for calculating a gripping force using a prescribed friction coefficient can be changed as appropriate. For example, the gripping force is calculated on the basis of the relational expression of the shear force, the gripping force, and the prescribed friction coefficient in the embodiment described above, but a table indicating a correspondence relationship among the shear force, the gripping force, and the prescribed friction coefficient may be stored in the storage device 3A. Then, a gripping force corresponding to a detected shear force may be acquired with reference to the table.

In the above-described embodiment, the same work may be repeatedly performed to cause the control unit 3 to perform machine learning. The storage device 3A may store a learned model.

The control unit 3 may calculate s gripping force on the basis of pressure distributions received from the sensor ICs 4A and 4B. The sensor IC 4A may calculate a gripping force on the basis of the pressure distribution acquired from the force sensor 20A, or the sensor IC 4B may calculate a gripping force on the basis of the pressure distribution acquired from the force sensor 20B.

### OTHER MODIFIED EXAMPLES

The embodiment and the modified examples thereof of the present disclosure have been specifically described above, but the present disclosure is not limited to the embodiment and modified examples described above thereof, and various modifications on the basis of the technical idea of the present disclosure are possible. For example, configurations, methods, steps, shapes, materials, numerical values, and the like described in the embodiment and modified examples described above are merely examples, and different configurations, methods, processes, shapes, materials, numerical values, and the like may be used as necessary. The configurations, methods, steps, shapes, materials, numerical values, and the like of the embodiment and modified examples described above can be combined with each other without departing from the gist of the present disclosure. In numerical value ranges described in stages in the embodiment and modified examples described above, an upper limit value or a lower limit value of a numerical value range of a certain stage may be replaced with the upper limit value or the lower limit value of the numerical value range of another stage. The materials exemplified in the embodiment and modified examples described above may be used alone or in combination of two or more unless otherwise specified.

Furthermore, the present disclosure can also adopt the following configurations.

(1)

A robot system including:

a robot; and

a control device that controls the robot, in which

the robot includes an actuator unit and an end effector provided at a distal end of the actuator unit,

the end effector includes a three-axis sensor configured to be capable of detecting a gripping force of the end effector and a shear force acting on a gripping surface of the end effector, and

the control device controls the gripping force of the end effector on the basis of a friction coefficient prescribed in advance and the shear force detected by the three-axis sensor.

(2)

The robot system according to (1), in which

the control device changes a direction of the end effector, reduces a gripping force of the end effector on the basis of the shear force detected by the three-axis sensor after the change in the direction, and changes a direction of a workpiece.

(3)

The robot system according to (2), in which

the control device changes the direction of the end effector from a vertical direction to a horizontal direction, gradually reduces the gripping force of the end effector on the basis of the shear force detected by the three-axis sensor after the change in the direction, and rotates the workpiece.

(4)

The robot system according to any one of (1) to (3), in which

the three-axis sensor includes:

a detection layer that has a first surface and a second surface on an opposite side of the first surface and includes a capacitive sensing unit;

a first conductive layer provided to oppose the first surface of the detection layer;

a second conductive layer provided to oppose the second surface of the detection layer;

a first deformable layer that is provided between the first conductive layer and the detection layer and is elastically deformed in response to a pressure acting in a sensor thickness direction; and

a second deformable layer that is provided between the second conductive layer and the detection layer and elastically deformed in response to the pressure acting in the sensor thickness direction.

(5)

The robot system according to (4), in which

the three-axis sensor further includes an exterior member on the first conductive layer, and

the exterior member contains at least one selected from a group consisting of rubber, gel, and foam.

(6)

The robot system according to any one of (1) to (5), in which

the friction coefficient is set to a value smaller than a static friction coefficient between the gripping surface and the workpiece.

(7)

The robot system according to any one of (1) to (6), in which

the control device calculates a gripping force for stably gripping the workpiece using the shear force detected by the three-axis sensor and the friction coefficient, and controls the gripping force of the end effector on the basis of a calculation result.

(8)

A robot hand according to any one of (1) to (7), in which

the end effector is used to grip a plurality of types of workpieces, and

the friction coefficient is set to a value smaller than a smallest friction coefficient among static friction coefficients between the gripping surface and the plurality of types of workpieces.

(9)

A control device including

a control unit that controls an end effector on the basis of a detection result of a three-axis sensor, in which

the three-axis sensor is configured to be capable of detecting a gripping force of the end effector and a shear force acting on a gripping surface of the end effector, and

the control unit controls the gripping force of the end effector on the basis of a friction coefficient prescribed in advance and the shear force detected by the three-axis sensor.

(10)

A control method including:

detecting, by a three-axis sensor, a shear force acting on a gripping surface of an end effector; and

controlling a gripping force of the end effector on the basis of a friction coefficient prescribed in advance and the shear force detected by the three-axis sensor.

### REFERENCE SIGNS LIST

1 Robot control device
2 Operation unit
3 Control unit
3A Storage device
4A, 4B Sensor IC
10 Articulated robot
11 Robot arm
12 Robot hand
13 Camera
20A, 20B Force sensor
120A, 120B Finger portion
122AS, 122BS Contact region

1. A robot system comprising:
a robot; and
a control device that controls the robot, wherein
the robot includes an actuator unit and an end effector provided at a distal end of the actuator unit,
the end effector includes a three-axis sensor configured to be capable of detecting a gripping force of the end effector and a shear force acting on a gripping surface of the end effector, and
the control device controls the gripping force of the end effector on a basis of a friction coefficient prescribed in advance and the shear force detected by the three-axis sensor.

2. The robot system according to claim 1, wherein
the control device changes a direction of the end effector, reduces a gripping force of the end effector on a basis of the shear force detected by the three-axis sensor after the change in the direction, and changes a direction of a workpiece.

3. The robot system according to claim 2, wherein
the control device changes the direction of the end effector from a vertical direction to a horizontal direction, gradually reduces the gripping force of the end effector on a basis of the shear force detected by the three-axis sensor after the change in the direction, and rotates the workpiece.

4. The robot system according to claim 1, wherein
the three-axis sensor includes:
a detection layer that has a first surface and a second surface on an opposite side of the first surface and includes a capacitive sensing unit;
a first conductive layer provided to oppose the first surface of the detection layer;
a second conductive layer provided to oppose the second surface of the detection layer;
a first deformable layer that is provided between the first conductive layer and the detection layer and is elastically deformed in response to a pressure acting in a sensor thickness direction; and
a second deformable layer that is provided between the second conductive layer and the detection layer and elastically deformed in response to the pressure acting in the sensor thickness direction.

5. The robot system according to claim 4, wherein
the three-axis sensor further includes an exterior member on the first conductive layer, and
the exterior member contains at least one selected from a group consisting of rubber, gel, and foam.

6. The robot system according to claim 1, wherein
the friction coefficient is set to a value smaller than a static friction coefficient between the gripping surface and the workpiece.

7. The robot system according to claim 1, wherein
the control device calculates a gripping force for stably gripping the workpiece using the shear force detected by the three-axis sensor and the friction coefficient, and controls the gripping force of the end effector on a basis of a calculation result.

8. A robot hand according to claim 1, wherein
the end effector is used to grip a plurality of types of workpieces, and
the friction coefficient is set to a value smaller than a smallest friction coefficient among static friction coefficients between the gripping surface and the plurality of types of workpieces.

9. A control device comprising
a control unit that controls an end effector on a basis of a detection result of a three-axis sensor,
wherein the three-axis sensor is configured to be capable of detecting a gripping force of the end effector and a shear force acting on a gripping surface of the end effector, and
the control unit controls the gripping force of the end effector on a basis of a friction coefficient prescribed in advance and the shear force detected by the three-axis sensor.

10. A control method comprising:
detecting, by a three-axis sensor, a shear force acting on a gripping surface of an end effector; and
controlling a gripping force of the end effector on a basis of a friction coefficient prescribed in advance and the shear force detected by the three-axis sensor.
